(19) United States
(12) Patent Application Publication
(10) Pub. No.: US 2006/0076463 A1
(43) Pub. Date: Apr. 13, 2006

(54) Flat panel display mounting apparatuses

(76) Inventor: Paul L. Drew, The Woodlands, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/963,871

(22) Filed: Oct. 13, 2004

(51) Int. Cl. F16L 3/00

(52) U.S. Cl. 248/121; 248/917; 361/681; 361/682; 248/919

(57) ABSTRACT

In at least one embodiment, a flat panel display mounting apparatus includes a mounting mechanism adapted to be placed between a flat panel display and a mounting plate of a display stand, the mounting mechanism including a retractable mounting tab that extends into a recess formed in a body of the mounting mechanism.

### BACKGROUND

Flat panel displays of the type often used with a personal computer (PC) typically mount to mounting plate of a display stand. Such an arrangement is shown in FIG. 1. As is indicated in that figure, a flat panel display 100 is provided with a plurality of mounting holes 102 that are formed through a back surface 104 of the display.

A display stand 106 is provided that includes a base 108 and a support column 110 that extends from the base. Extending from the top of the support column 110 is a swing arm 112 that, for example, can be pivoted relative to the support column to adjust the orientation of the display 100 once it is mounted to the stand 106.

Positioned at the end of the swing arm 112 is a mounting plate 114 that includes a plurality of mounting holes 116 that are arranged in the same orientation as the mounting holes 102 of the display 100. By way of example, the mounting plate 114 and its holes 116, as well as the display's mounting holes 102, comply with the video electronics standards association (VESA) mounting standard that has been established for flat panel displays.

To mount the display 100 to the stand 106, threaded fasteners 118, such as screws, are passed through the mounting holes 116 of the mounting plate 114 and are threaded into the mounting holes 102 of the display.

Although the mounting arrangement described above and illustrated in FIG. 1 adequately supports flat panel displays, that arrangement does not facilitate rapid removal and replacement of such displays. If the flat panel display must be replaced, for instance if the display fails, each of the four fasteners that hold the display to its stand must be unscrewed, and then re-threaded into the replacement display. This time-consuming process can be disruptive to the user, especially in situations in which it is important for the user to be able to view data continuously to monitor changing information. In addition, it may be difficult to locate a screwdriver, which is required to remove and replace the fasteners. If such a screwdriver or a suitable substitute cannot be located, the display cannot be removed and replaced.

### SUMMARY

In at least one embodiment, a flat panel display mounting apparatus includes a mounting mechanism adapted to be placed between a flat panel display and a mounting plate of a display stand, the mounting mechanism including a retractable mounting tab that extends into a recess formed in a body of the mounting mechanism.

### BRIEF DESCRIPTION OF THE DRAWINGS

The disclosed apparatuses can be better understood with reference to the following drawings. The components in the drawings are not necessarily to scale.

FIG. 1 is an exploded perspective view illustrating a conventional flat panel display mounting arrangement.

FIG. 2 is a front perspective view of an embodiment of a first mounting mechanism that can be used to mount a flat panel display to a display stand.

FIG. 3 is a rear perspective view of the mounting mechanism shown in FIG. 2.

FIGS. 4A and 4B are cut-away front views of the mounting mechanism shown in FIGS. 2 and 3, illustrating operation of a retractable mounting tab of the mechanism.

FIG. 5 is a front perspective view of the mounting mechanism shown in FIGS. 2-4, illustrating retraction of the mounting tab.

FIG. 6 is an exploded perspective view illustrating attachment of the mounting mechanism shown in FIGS. 2-6 to a flat panel display.

FIGS. 7A and 7B are side views of the flat panel display, mounting mechanism, and a display stand shown in FIG. 6, illustrating mounting of the display on the stand.

FIG. 8 is a rear perspective view of the flat panel display and the display stand shown in FIGS. 7A and 7B, with the display shown mounted on the stand.

FIG. 9 is a front perspective view of an embodiment of a second mounting mechanism that can be used to mount a flat panel display to a display stand.

FIG. 10 is a front perspective view of the mounting mechanism shown in FIG. 9 with mounting tabs of the mechanism placed in a retracted position.

FIG. 11 is a front perspective view of the mounting mechanism shown in FIGS. 9 and 10, illustrating tab-receiving slots provided within the mechanism.

FIG. 12 is a front perspective view of an embodiment of an adapter that can be used in conjunction with the mounting mechanism shown in FIGS. 9-11 to mount a flat panel display on a display stand.

FIG. 13 is an exploded perspective view illustrating mounting of the mounting mechanism shown in FIGS. 9-11 to a flat panel display.

FIG. 14 is an exploded perspective view illustrating mounting of the adapter shown in FIG. 12 to a display stand.

FIGS. 15A and 15B are side views of the flat panel display, and mounting mechanism shown in FIG. 13 and the display stand and adapter shown in FIG. 14, illustrating mounting of the display on the stand.

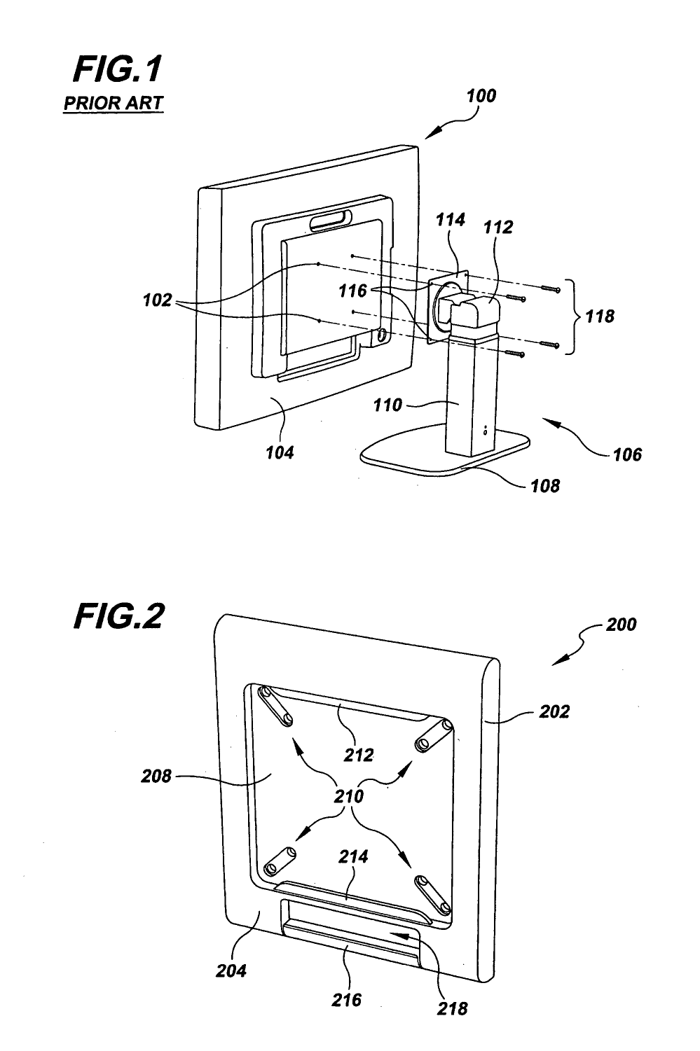

### DETAILED DESCRIPTION

Disclosed herein are flat panel display mounting apparatuses that enable rapid removal and/or replacement of a flat panel display relative to a display stand. More particularly, disclosed are quick-release mounting apparatuses that enable a display to be quickly removed from or mounted to a display stand without the need for any tools, such as a screwdriver. In one embodiment, a mounting mechanism is provided that attaches to a flat panel display and that includes tabs that grip a mounting plate of a display stand. In another embodiment, a mounting apparatus includes an adapter that attaches to the display stand mounting plate and a mounting mechanism of the flat panel display that interfaces with the adapter.

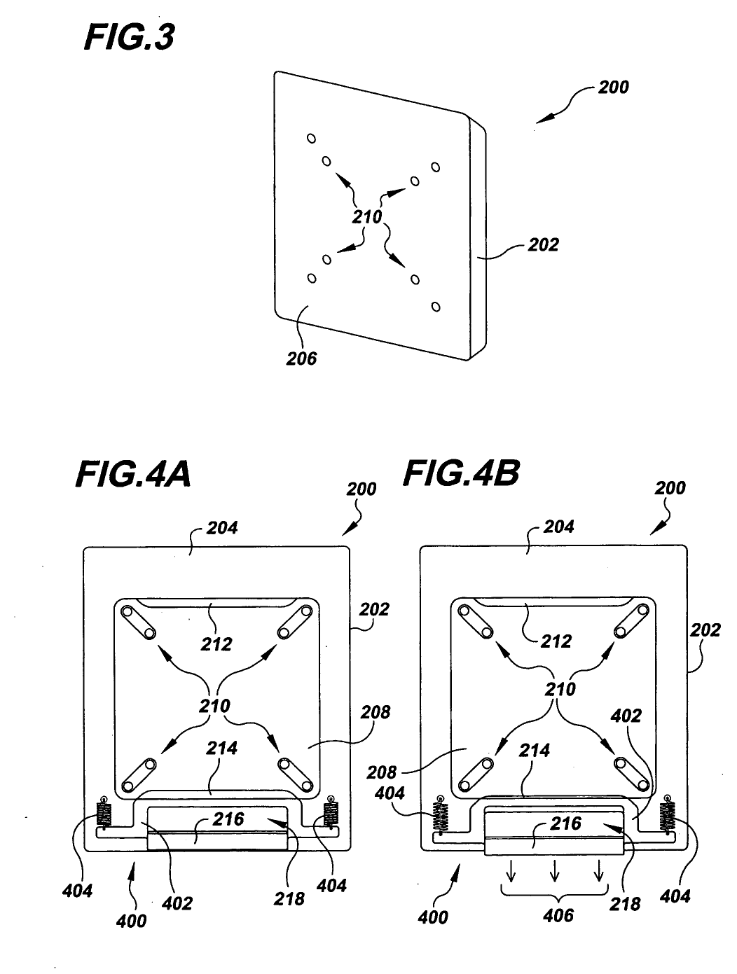

Referring now in more detail to the drawings, in which like numerals indicate corresponding parts throughout the several views, FIGS. 2-8 illustrate an embodiment of a first flat panel display mounting apparatus. More particularly, those figures illustrate a first mounting mechanism 200. With reference first to FIGS. 2 and 3, the mounting mechanism 200 comprises a body 202 having a front side that defines a front surface 204 and a rear side that defines a rear surface 206. By way of example, the body 202 is a hollow enclosure formed of a moldable material, such as a polymeric material.

Formed in the front side of the body 202 is a recess 208 that is sized and configured to receive a VESA-compliant mounting plate. Accordingly to current VESA mounting standards, such a mounting plate has height and width dimensions of 90 millimeters (mm) or 115 mm, depending upon the mounting hole spacing used (see below). Formed within the recess 208 is a plurality of mounting holes 210 that, as is apparent from FIG. 3, extend through the body 202 from the front side to the back side of the body. By way of example, two sets of four mounting holes 210 are provided, such that a total of eight mounting holes are provided. The mounting holes 210 are positioned so as to comply with the VESA mounting standards. Therefore, for example, a first set of the mounting holes 210 are spaced approximately 75 mm from each other, while a second set of the mounting holes 210 are spaced approximately 100 mm from each other (dimensions between holes in vertical and horizontal directions).

With specific reference to FIG. 2, the mounting mechanism 200 further includes opposed mounting tabs 212, 214 that are located within the space defined by the recess 208. Specifically, an upper mounting tab 212 is provided opposite to a lower mounting tab 214. As is described in greater detail below, the mounting tabs 212, 214 are adapted to grip top and bottom edges of a display stand mounting plate to secure a flat panel display, to which the mounting mechanism 200 is attached, to the display stand. By way of example, the mounting tabs 212, 214 are constructed of a metal material, such as steel. As is also described below, the lower mounting tab 214 is retractable so as to facilitate mounting and removal of the flat panel display relative to the display stand. The lower mounting tab 214 is retracted using a lever 216 that is positioned within a second recess 218 provided in the front side of the mounting mechanism 200.

Referring now to FIGS. 4A and 4B, depicted is a retraction mechanism 400 that is used to retract the lower mounting tab 214 from an initial position, and return the lower mounting tab 214 to the initial position. As is illustrated in FIGS. 4A and 4B, the retraction mechanism 400 includes a retractor member 402 that is contained within the body 202 and that is connected to both the lower mounting tab 214 and the lever 216. By way of example, the retractor member 402 is unitarily-formed with the lower mounting tab 214 and, therefore, is made of the same material as the lower mounting tab (e.g., steel). Attached to each end of the retractor member 402 are springs 404. The opposite ends of those springs 404 are attached to the body 202 such that the springs are held in tension and, therefore, bias the retractor member 402, and the lower mounting tab 214, toward the initial, extended or “unretracted” position shown in FIG. 4A. Although two springs 404 are illustrated, greater or fewer springs can be used. Moreover, although coil springs are illustrated, any other suitable biasing element could be used to bias the retractor member 402.

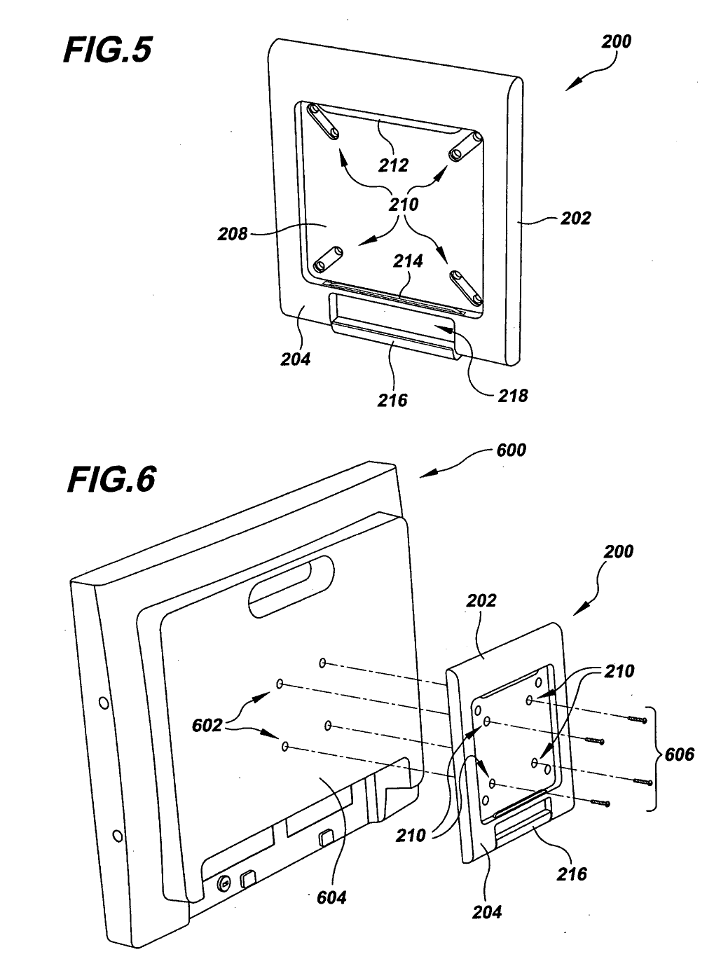

When the lever 216 is moved downward, as is indicated by arrows 406 in FIG. 4B, the retractor member 402 and the lower mounting tab 214 are likewise moved downward. As is indicated in FIG. 5, this movement results in the lower mounting tab 214 being retracted into the body 202 of the mounting mechanism 200 from the space defined by the recess 208. Accordingly, the distance between the upper mounting tab 212 and the lower mounting tab 214 is increased so as to permit passage of a display stand mounting plate into or out from the recess 208.

Referring next to FIG. 6, attachment of the mounting mechanism 200 to a flat panel display 600 is depicted. The flat panel display 600 is provided with a plurality (e.g., four) mounting holes 602 that extend into a rear surface 604 of the display. The mounting mechanism 200 can be attached to the rear surface 604 of the flat panel display 600 with threaded fasteners 606 that are passed through mounting holes 210 of the mounting mechanism, which align with the mounting holes 602 of the display.

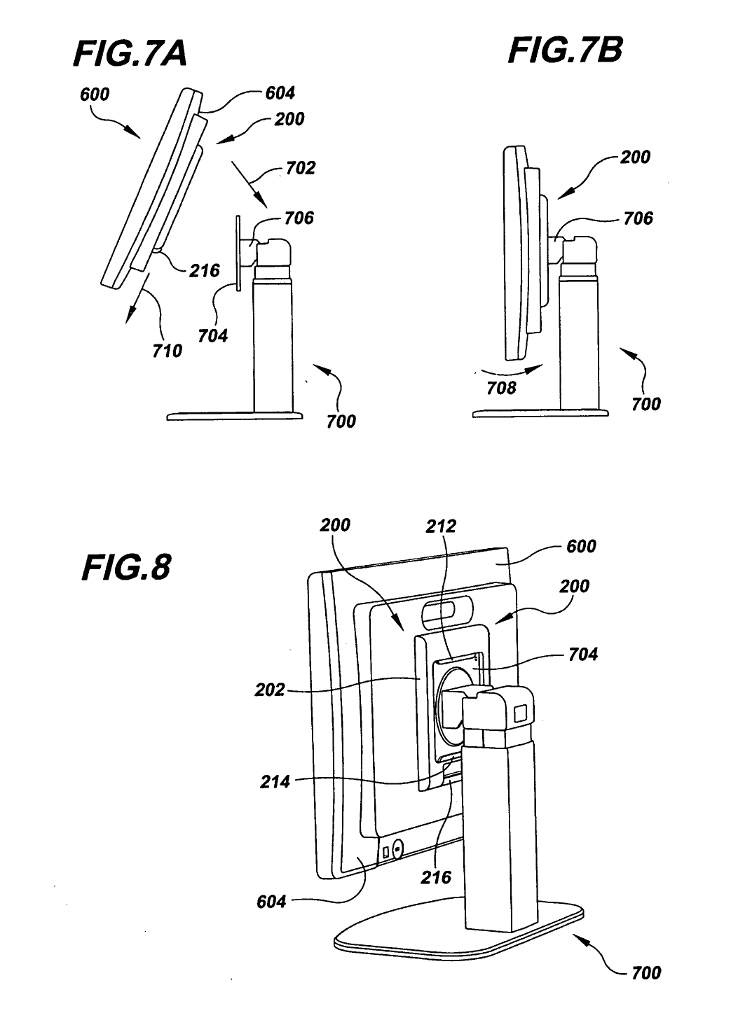

After the mounting mechanism 200 has been attached to the flat panel display 600 in the manner described in relation to FIG. 6, the display can be mounted on a display stand. The mounting process is depicted in FIGS. 7A and 7B. Beginning with FIG. 7A, the flat panel display 600 is moved toward the display stand 700 in the direction of arrow 702 with the rear surface 604 facing the stand. As is indicated in FIG. 7A, the flat panel display 600 may be moved toward the display stand 700 from a raised position so as to enable the upper mounting tab 212 (FIG. 2) to grip a top edge of a mounting plate 704 of the display stand that is positioned at the end of a swing arm 706 of the stand. Once the upper mounting tab 212 engages the mounting plate 704, the bottom of the flat panel display 600 can be pivoted toward the display stand 700 in the direction of arrow 708 in FIG. 7B. Before the mounting plate 704 is received by the mounting mechanism recess 208 (FIG. 2) however, the lower mounting tab 214 (FIG. 2) is retracted using the lever 216, as indicated by arrow 710 in FIG. 7A, to allow the mounting plate to pass into the recess 208, at which point the lever may be released. At that point, the flat panel display 600 is mounted to the display stand 700 in the manner shown in FIG. 7B.

When the flat panel display 600 is mounted in the above-described manner, the upper and lower mounting tabs 212, 214 grip the display stand mounting plate 704 as shown in FIG. 8 to secure the mounting mechanism 200, and the display to which the mechanism is attached, to the display stand 700. As is apparent in FIG. 8, the display stand mounting plate 704 is held between the mounting tabs 212, 214 and the mounting mechanism body 202 (i.e., within the recess 208; FIG. 2).

The flat panel display 600 can be removed from the display stand 700 by reversing the process described above. Specifically, the lever 216 can be moved downward to retract the lower mounting tab 214 so as to enable the bottom of the flat panel display 600 to be pivoted away from the display stand 700 to partially remove the display stand mounting plate 704 from the mounting mechanism recess 208. The flat panel display 600 can then be simply lifted up off of the display stand to disengage the upper mounting tab 212 from the mounting plate 704.

From the above, it can be appreciated that flat panel displays having the attached mounting mechanism 200 can be quickly and easily mounted to and removed from a display stand without the need for any tools. Accordingly, a nonfunctioning display can be rapidly replaced so as to minimize inconvenience to the display user.

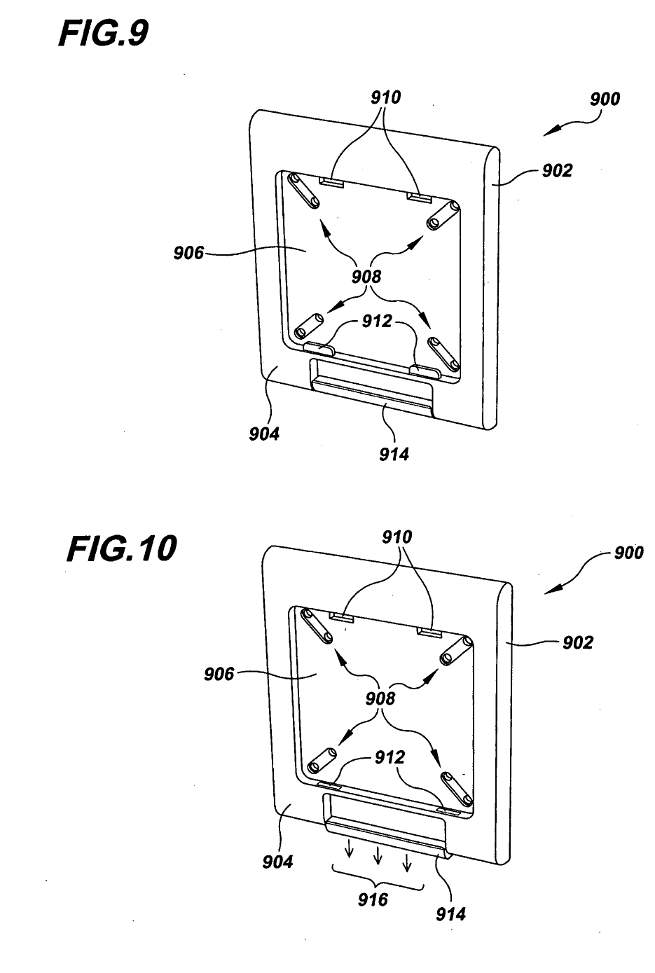

FIGS. 9-15 illustrates an embodiment of a second flat panel display mounting apparatus. Beginning with FIGS. 9-11, illustrated is a second mounting mechanism 900 of the second mounting apparatus. Although the mounting mechanism, 900 is shown in FIGS. 9 and 10 as comprising an independent part, the mounting mechanism can, in some embodiments, comprise an integral part of a flat panel display. The mounting mechanism 900 is shown and described as a separate part, however, in the following for purposes of example.

The second mounting mechanism 900 shares several of the features of the first mounting mechanism 200 described in relation to FIGS. 2-8 above. Accordingly, the mounting mechanism 900 comprises a body 902 having a front side that defines a front surface 904 and a rear side (not shown) that defines a rear surface. By way of example, the body 902 is a hollow enclosure formed of a moldable material, such as a polymeric material.

Formed in the front side of the body 902 is a recess 906 that is sized and configured to receive a VESA-compliant mounting plate. Formed within the recess 906 is a plurality of mounting holes 908 that extend through the body 902 from the front side to the back side of the body. By way of example, two sets of four mounting holes 908 are provided in similar manner to that described in relation to the first mounting mechanism 200.

Instead of two opposed mounting tabs, however, the mounting mechanism 900 comprises tab-receiving openings 910 formed in the body 902 adjacent the top of the recess 906, and mounting tabs 912 positioned adjacent the bottom of the recess. The openings 910 are adapted to receive tabs of an adapter that is attached to a mounting plate of a display stand. The mounting tabs 912 are retractable in similar manner to that described above in relation to the lower mounting tab 214 of the first mounting mechanism 200 and may be biased in similar manner to the biasing of the lower mounting tab. Therefore, as is indicated in FIG. 10, the mounting tabs 912 can be retracted into the mechanism body 902 by moving the lever 914 in the direction of arrows 916, against the force of one or more biasing elements (e.g., springs). As is described in greater detail below, the mounting tabs 912 can be received by slots of the adapter that is attached to the display stand mounting plate.

FIG. 12 illustrates an embodiment of an adapter 1200 that can be attached to a display stand mounting plate. As is indicated in FIG. 12, the adapter 1200 comprises a central plate 1202 that includes a plurality of mounting holes 1204 that extend through the plate. Although four such mounting holes 1204 are shown in FIG. 12, eight holes can be provided in the plate 1202 so as to accommodate two different VESA mounting standards.

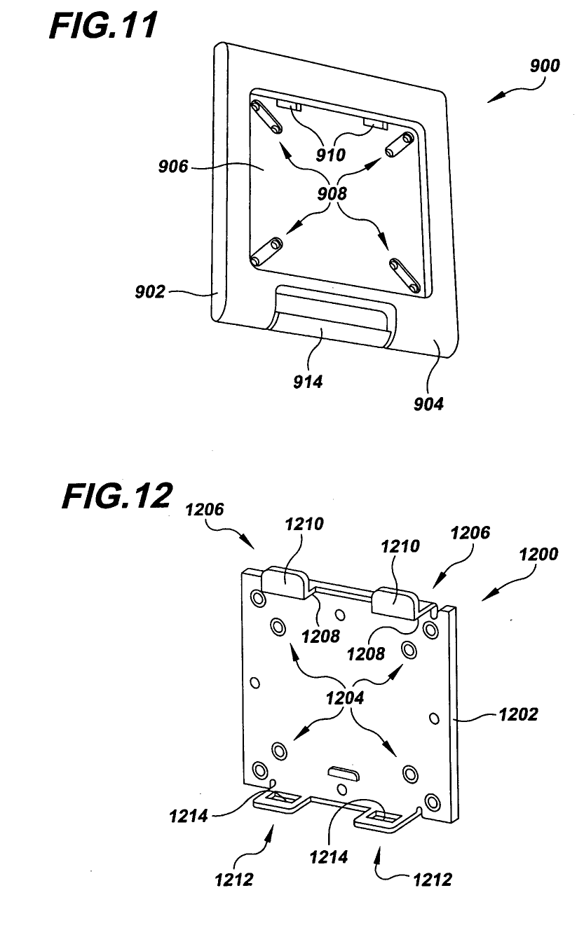

Extending from the top of the plate 1202 are mounting tabs 1206. As is indicated in FIG. 12, the mounting tabs 1206, in the illustrated embodiment, are L-shaped so as to include a horizontal portion 1208 that extends from the plate, and a vertical portion 1210 that extends upward from the horizontal portion. With this configuration, the mounting tabs 1206 are adapted to pass into the tab-receiving openings 910 of the mounting mechanism 900 (see FIG. 11).

Extending horizontally from the bottom of the plate 1202 are tab-receiving members 1212 that include tab-receiving slots 1214. The slots 1214 are specifically adapted for receiving the mounting slots 912 of the mounting mechanism 900 (see FIG. 9).

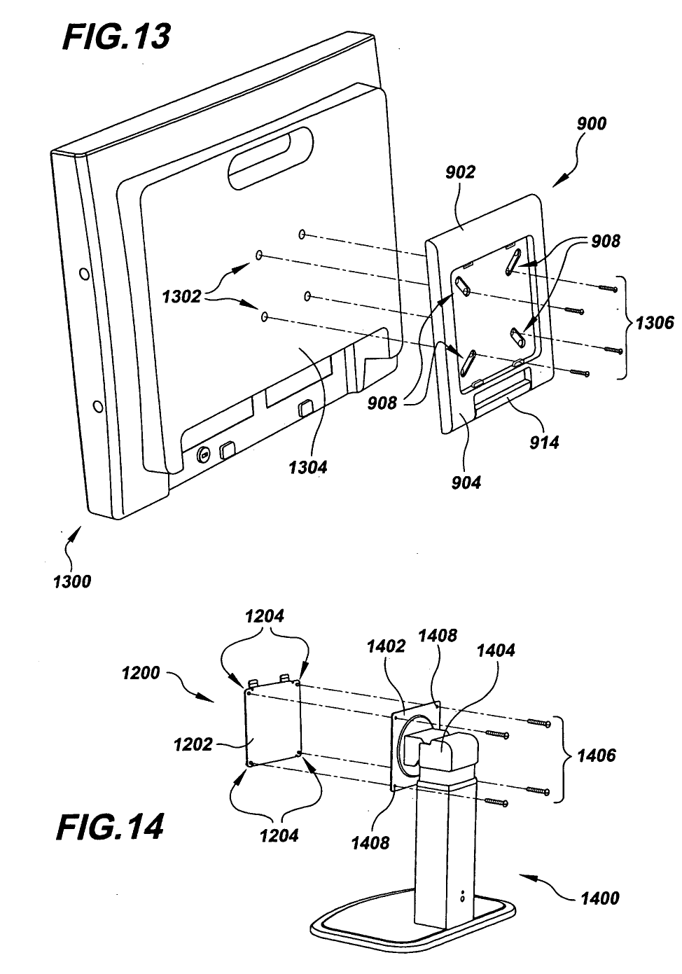

In embodiments in which the mounting mechanism 900 is separate from the flat panel display, the mechanism is attached to the display prior to mounting the display on a display stand. FIG. 13 illustrates such attachment of the mounting mechanism 900 to a flat panel display 1300. The flat panel display 1300 is provided with a plurality (e.g., four) mounting holes 1302 that extend into a rear surface 604 of the display. The mounting mechanism 900 can be attached to the rear surface 1304 of the flat panel display 1300 with threaded fasteners 1306 that are passed through mounting holes 908 of the mounting mechanism that align with the mounting holes 1302 of the display.

In embodiments in which the mounting mechanism 900 forms part of the flat panel display, i.e., the display is constructed so as to comprise an integral mounting mechanism, no such attachment is necessary. In such a case, the mounting holes 908 of the display mounting mechanism can be omitted.

Referring next to FIG. 14, depicted is attachment of the adapter 1200 to a display stand 1400. As is indicated in FIG. 14, the adapter 1200 attaches to a mounting plate 1402 that is positioned on a swing arm 1404 of the stand 1400 using threaded fasteners 1406, such as screws, that extend through mounting holes 1408 of the plate and into the mounting holes 1204 of the adapter plate 1202. In such an arrangement, the mounting holes 1204 of the adapter 1200 are threaded to receive the threads of the fasteners 1406. In alternative embodiments, however, the adapter 1200 can be attached to the display stand mounting plate 1402 with nuts and bolts. In such a case, the mounting holes 1204 need not be threaded.

As is apparent in FIG. 14, the display stand mounting plate 1402 is not square as is specified by VESA mounting standards. In particular, the mounting plate 1402 is X-shaped. Use of the adapter 1200 enables a secure interface between the mounting mechanism 900 and the display stand. Accordingly, the second mounting apparatus can be used to mount flat panel displays to display stands that do not comply with VESA mounting standards.

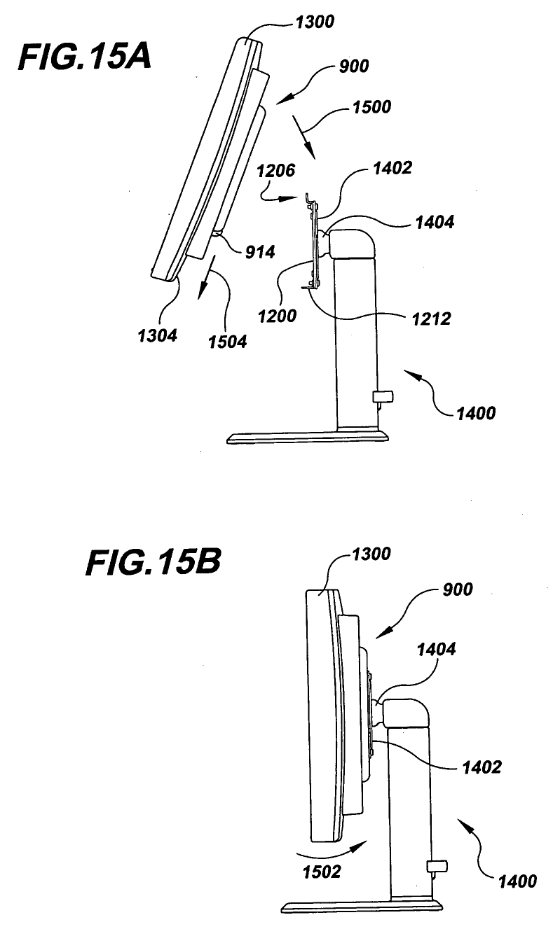

Referring now to FIGS. 15A and 15B, illustrated is an example of mounting of the flat panel display 1300 to the display stand 1400. Beginning with FIG. 15A, the flat panel display 1300 is moved toward the display stand 1400 in the direction of arrow 1500 with the rear surface 1304 facing the stand. As is indicated in FIG. 15A, the flat panel display 1300 may be moved toward the display stand 1400 from a raised position so as to enable the mounting tabs 1206 of the adapter 1200 to pass into the tab-receiving openings 910 (FIG. 11) of the mounting mechanism 900 that is attached to or integrated with the display 1300.

Once the mounting tabs 1206 are received by the tab-receiving openings 910, the bottom of the flat panel display 1300 can be pivoted toward the display stand 1400 as is indicated by arrow 1502 in FIG. 15B. Before the adapter 1200 is received by the mounting mechanism recess 906 (FIG. 9), the mounting tabs 912 (FIG. 9) of the mounting mechanism 900 are retracted using the lever 914, as indicated by arrow 1504 in FIG. 15A, to allow the adapter to pass into the recess. At that point, the lever 914 may be released such that the flat panel display 1300 is mounted to the display stand 1400 in the manner shown in FIG. 15B.

What is claimed is:

1. A flat panel display mounting apparatus, comprising:
a mounting mechanism adapted to be placed between a flat panel display and a mounting plate of a display stand, the mounting mechanism including a retractable mounting tab that extends into a recess formed in a body of the mounting mechanism.

2. The apparatus of claim 1, wherein the recess is adapted to receive a VESA-compliant mounting plate of the display stand.

3. The apparatus of claim 2, wherein the retractable mounting tab is adapted to grip a first edge of the mounting plate.

4. The apparatus of claim 3, wherein the mounting mechanism further includes a further mounting tab positioned opposite to the retractable mounting tab and adapted to grip a second edge of the mounting plate, wherein the mounting mechanism grips the mounting plate between the two mounting tabs.

5. The apparatus of claim 1, further comprising an adapter that attaches to the mounting plate, wherein the mounting mechanism recess is adapted to receive the adapter.

6. The apparatus of claim 5, wherein the adapter includes a mounting tab and the mounting mechanism includes a tab-receiving opening formed within the recess, the adapter mounting tab being receivable in the tab-receiving opening.

7. The apparatus of claim 5, wherein the adapter includes a tab-receiving member that includes a slot that is adapted to receive the retractable mounting tab of the mounting mechanism when the adapter is positioned within the mounting mechanism recess.

8. The apparatus of claim 1, wherein the mounting mechanism includes mounting holes that enable the mounting mechanism to be attached to the flat panel display.

9. The apparatus of claim 1, wherein the mounting mechanism is integrated with the flat panel display so as to form part of the flat panel display.

10. The apparatus of claim 1, further comprising a biasing element that biases the retractable mounting tab toward an extended position.

11. The apparatus of claim 10, wherein the biasing element includes a spring that is provided within the body of the mounting mechanism.

12. A flat panel display mounting apparatus, comprising:
means for receiving a mounting plate of a display stand; and
means for releasably gripping the received mounting plate, the means for releasably gripping being configured such that the mounting plate can be gripped to mount a flat panel display to the display stand and released to remove the flat panel display from the display stand without the use of any tools.

13. The apparatus of claim 12, wherein the means for receiving comprise a recess in which the mounting plate can be positioned.

14. The apparatus of claim 13, wherein the means for releasably gripping comprise opposed mounting tabs that grip the edges of the mounting plate when the plate is positioned within the recess, at least one of the mounting tabs being retractable.

15. A flat panel display mounting apparatus, comprising:
means for adapting a mounting plate of a display stand;
means for receiving the means for adapting; and
means for releasably securing the means for adapting, the means for releasably securing being configured such that the means for adapting can be secured to mount a flat panel display to the display stand and released to remove the flat panel display from the display stand without the use of any tools.

16. The apparatus of claim 15, wherein the means for adapting comprise an adapter that attaches to the mounting plate.

17. The apparatus of claim 16, wherein the means for receiving comprise a recess in which the adapter can be positioned.

18. The apparatus of claim 17, wherein the means for releasably securing comprise a mounting tab and a tab-receiving member of the adapter and a tab-receiving opening and a retractable mounting tab associated with the recess, the adapter mounting tab being receivable in the tab-receiving opening and the retractable mounting tab being receivable in the adapter tab-receiving member.

19. A display mounting mechanism, comprising:
a body;
a recess formed in the body, the recess being adapted to receive a display stand mounting plate;
a first mounting tab positioned at a first side of the recess; and
a second mounting tab positioned at a second side of the recess, the second side being opposite to the first side, the second mounting tab being retractable such that the distance between the first and second mounting tabs can be changed to enable and disable passage of the mounting plate into and out from the recess.

20. The mechanism of claim 19, wherein the recess is adapted to receive a VESA-compliant mounting plate.

21. The mechanism of claim 19, further comprising mounting holes positioned within the recess that extend through the body.

22. The mechanism of claim 19, further comprising a lever that is used to retract the second mounting tab.

23. The mechanism of claim 19, further comprising a biasing element that biases the second mounting tab toward an extended position.

24. A display mounting apparatus, comprising:
an adapter that attaches to a display stand mounting plate, the adapter including a mounting tab and a tab-receiving member; and
a mounting mechanism including a body having a recess formed therein, the recess being adapted to receive the adapter, the mounting mechanism further including a tab-receiving opening positioned within the recess that is adapted to receive the adapter mounting tab and a retractable mounting tab positioned within the recess that is adapted to be received by the adapter tab-receiving member.

25. The apparatus of claim 24, wherein the mounting mechanism is integrated with a flat panel display so as to form a part of the display.

26. The apparatus of claim 24, wherein the mounting mechanism further includes a lever that is used to retract the retractable mounting tab.

27. The mechanism of claim 24, further comprising a biasing element that biases the retractable mounting tab toward an extended position.

28. A flat panel display, comprising:
a rear surface; and
a mounting mechanism positioned on the rear surface, the mounting mechanism including a retractable mounting tab that extends into a recess formed in a body of the mounting mechanism.

29. The display of claim 28, wherein the mounting mechanism recess is adapted to receive an adapter that attaches to a display stand mounting plate and wherein the mounting mechanism includes a tab-receiving opening that is adapted to receive a mounting tab of the adapter and a retractable mounting tab that is adapted to be received by a tab-receiving member of the adapter.
